(19) United States
(12) Patent Application Publication
(10) Pub. No.: US 2024/0160835 A1
(43) Pub. Date: May 16, 2024

(54) KEY PERFORMANCE INDICATOR PERFORMANCE REPORT APPARATUS AND METHOD

(71) Applicant: Rakuten Mobile, Inc., Tokyo (JP)

(72) Inventors: Vishvesh TRIVEDI, Tokyo (JP); Anshul BHATT, Tokyo (JP); Dhananjay CHAUBEY, Tokyo (JP); Alok Singh PAWAR, Madhya Pradesh (IN); Manish PATIDAR, Madhya Pradesh (IN)

(21) Appl. No.: 17/757,827

(22) PCT Filed: Apr. 27, 2022
(86) PCT No.: PCT/US2022/026433

§ 371 Date: Jun. 22, 2022

(51) Int. Cl. G06F 40/166; G06F 3/0482; G06F 3/0486; G06F 40/103; H04L 43/045

(52) U.S. Cl. CPC G06F 40/166; G06F 3/0482; G06F 3/0486; G06F 40/103; H04L 43/045

(57) ABSTRACT

A method includes processing one or more parameter selection inputs received by way of a graphical user interface including a plurality of parameter input fields. Each parameter input field is configured to receive a parameter selection corresponding to a detail for generating a performance report. The method also includes processing one or more node selection inputs received by way of the graphical user interface. The method further includes causing a list of one or more key performance indicators (KPIs) associated with monitoring a communication network to be populated based on the parameter selection input(s) and the node selection input(s). The method additionally includes causing one or more of the KPIs to be selected for inclusion in the performance report, processing a time range and/or a frequency for generating the performance report, and causing the performance report to be generated based on the time range and/or the frequency.

### BACKGROUND

Network operators, network service providers and device manufacturers (e.g., wireless, cellular, etc.) are continually challenged to deliver value and convenience to consumers by, for example, providing compelling communication networks and network services that are dependable and capable of being flexibly constructed, scalable, diverse, and economically operated. To provide such communication networks and network services, network operators, network service providers and device manufacturers often track key performance indicators (KPIs) that are indicative of an operating state of a communication network and/or various network services and/or network devices.

### BRIEF DESCRIPTION OF DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram of a KPI monitoring and centralized data storage system, in accordance with one or more embodiments.

FIG. 2 is a diagram of a graphical user interface, in accordance with one or more embodiments.

FIG. 3 is a diagram of a graphical user interface, in accordance with one or more embodiments.

FIG. 4 is a diagram of a graphical user interface, in accordance with one or more embodiments.

FIG. 5 is a diagram of a graphical user interface, in accordance with one or more embodiments.

FIG. 6 is a diagram of a graphical user interface, in accordance with one or more embodiments.

FIG. 7 is a flowchart of a process for generating a performance report associated with monitoring one or more KPI values, in accordance with one or more embodiments.

FIG. 8 is a functional block diagram of a computer or processor-based system upon which or by which an embodiment is implemented.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation or position of a first feature over or on a second feature in the description that follows may include embodiments in which the first and second features are formed or positioned in direct contact, and may also include embodiments in which additional features may be formed or positioned between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of an apparatus or object in use or operation in addition to the orientation depicted in the figures. The apparatus may be otherwise oriented (rotated 90 degrees or at other orientations) and the spatially relative descriptors used herein may likewise be interpreted accordingly.

Communication networks and network services are often provided by static or inflexible systems that are difficult to configure, scale, and deploy over various target areas. Dependable provision of communication networks and/or network services that are capable of being flexibly constructed, scalable and diverse is often reliant on the collection, analysis and reporting of information regarding multiple network functions, network services, network devices, etc. that affect the performance, accessibility, configuration, scale, and/or deployment of a communication network, various network functions, network services, and the like.

Network service providers often deploy network monitoring systems that track various key performance indicators (KPIs) of an aspect of a network for determining how well that aspect and/or the network is performing. KPIs are often KPI values and/or trends that are compared to certain thresholds to indicate the relative performance of a communication network, network service, network device, etc. The KPI values are often based on monitoring data referred to herein as system data.

Sometimes, when a KPI value for a certain network function, network service or feature is below a preset threshold, the KPI value may imply that the network is operating normally, whereas when the KPI value is above or equal to the preset threshold, the KPI value implies that the network is operating below expectation, which in turn may indicate that some unexpected event (e.g., a hardware failure, capacity overload, a cyberattack, etc.) has occurred. Accordingly, a series of actions can be carried out by the network monitoring system such as alerting the network operator, shifting a network function from a problematic server to a healthy server, temporarily shutting down the network, or some other suitable action. Of course, depending on the network configuration, a condition in which the KPI value is higher than or equal to a threshold can also indicate that the network is operating normally, while a condition in which the KPI value is below the threshold indicates that the network is operating below expectation. Several other types of threshold configurations are possible as the threshold configurations may vary depending on the needs of a specific user or specific network operator, depending on individual preference, type of KPI being monitored, type of KPI created by a user for monitoring, type of system data that is processed for monitoring a KPI, and the like.

Network operators that coordinate and deploy communication networks that include network services (e.g., hardware, software, etc.) provided by one or more network service providers are reliant on system data supplied to the network operator by the one or more network service providers for monitoring KPIs. Such communication networks often involve network services across multiple domains such as radio area network (RAN), base station subsystem (BSS), platform, core network, etc., various technologies (such as 3G, 4G, LTE, 5G, etc.), multiple locations, various software interfaces, multiple devices, etc. that are proprietary and/or optimized by a specific network service provider.

As the communication network evolves and improves, a single communication network may involve an ever-changing quantity of network service providers for providing network services and/or that are associated with providing network services associated with various aspects of the communication network (e.g., domains, technologies, locations of services, etc.) and, as a result, the state of the communication network may vary dynamically with the addition and/or subtraction of network service providers, a change in one or more network services, etc.

Each network service provider often uses a corresponding monitoring system to monitor performance of the network service(s) provided by that network service provider to gather various system data (e.g., raw data, processed data, and/or pre-processed data provided by a network service provider's monitoring system, pre-processed KPI data provided by the network service providers, etc.) usable by the network operator for determining KPI values indicative of the state of the communication network. The network service providers send the system data to the network operator for monitoring the status of the communication network in consideration of the system data associated with the network service(s) provided by each network service provider. For example, the network operator uses the system data supplied by the network service providers to generate KPI value(s) and/or to evaluate the quality of services provided by each of the network service providers.

Network operators consistently check KPIs, for example, to ensure validity and stability of the communication network. Then, based on a determination that an anomaly occurs in one or more KPIs, take an appropriate action such as making a change in network service providers or network devices that are used to provide one or more network services that are malfunctioning to one or more alternative network service providers and/or one or more alternative network devices to ensure the communication network is operating and available for consumers.

As the communication network evolves, the services, network devices, coverage area, network service providers, etc., may change, a quantity of various KPIs may change, and monitoring of the communication network becomes increasingly complicated. For example, a KPI monitoring system may have thousands of KPIs that may or may not be applicable to various scenarios within the communication network, and monitoring all of those KPIs individually or for an initially created purpose may be difficult or not applicable to a user or for monitoring various aspects of the communication network.

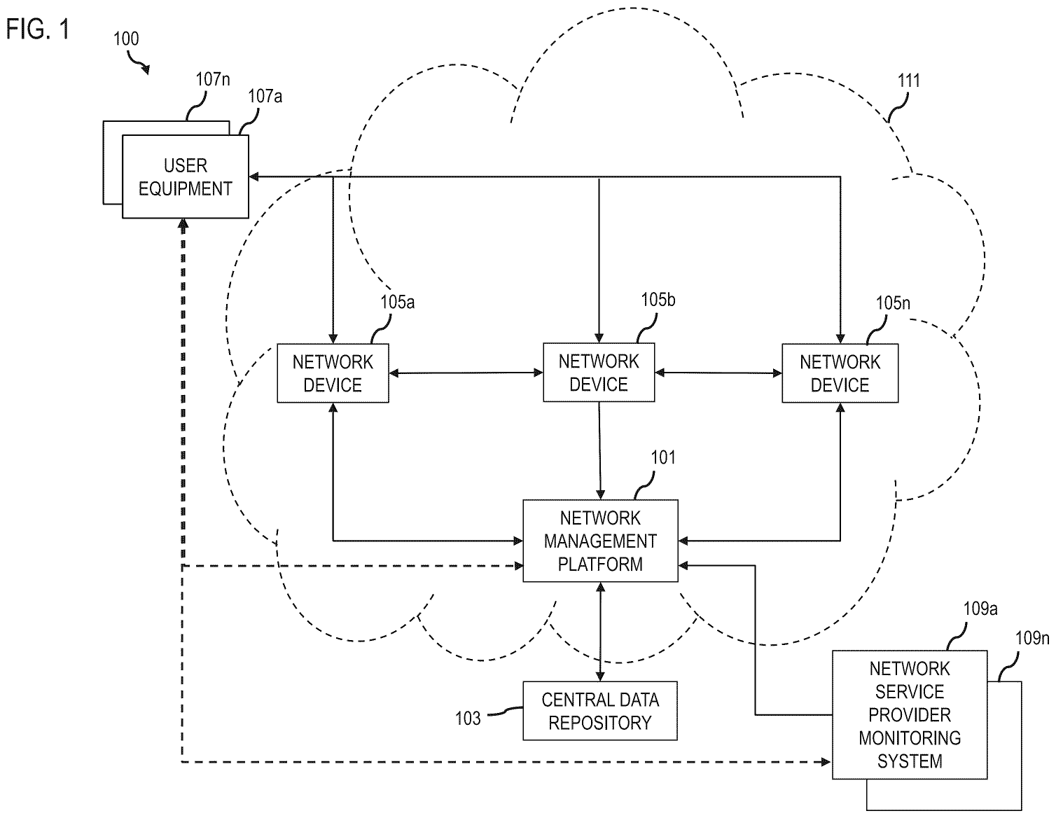

FIG. 1 is a diagram of a KPI monitoring and centralized data storage system 100, in accordance with one or more embodiments.

System 100 makes it possible for a network operator to monitor KPIs associated with a communication network provided by the network operator based on system data received from one or more network service providers that provide network services upon which the communication network is based. System 100 also makes it possible to simplify the monitoring of the communication network by facilitating the generation of performance reports that include KPI value(s) regarding one or more KPIs that are being monitored.

System 100 comprises a network management platform 101, a central data repository 103, one or more network devices 105a-105n (collectively referred to as network devices 105), and one or more user equipment (UE) 107a-107n (collectively referred to as UE 107). The network management platform 101, the central data repository 103, the one or more network devices 105, and/or the one or more user equipment (UE) 107 are communicatively coupled by way of a communication network 111. In some embodiments, the communication network 111 is orchestrated by the network management platform 101 which combines a plurality of network services provided by a network service provider via the network devices 105. In some embodiments, the network management platform 101 is a network orchestrator that implements the communication network 111. In some embodiments, the network management platform 101 is a portion of a network orchestrator that implements the communication network 111.

The network service providers associated with the network services provided have corresponding network service provider monitoring systems 109a-109n (collectively referred to as network service provider monitoring system 109). The network service provider monitoring systems 109 collect system data associated with the network services provided to communication network 111 and send that system data to the network management platform 101 to facilitate monitoring of the state of the communication network 111.

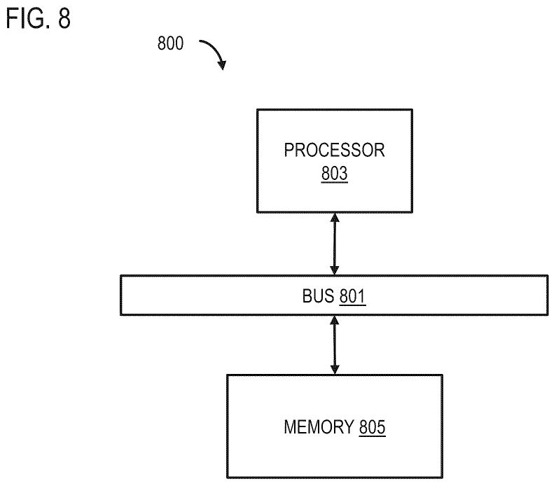

In some embodiments, network management platform 101 comprises a set of computer readable instructions that, when executed by a processor such as a processor 803 (FIG. 8), causes network management platform 101 to perform the processes discussed in accordance with one or more embodiments. In some embodiments, network management platform 101 is remote from the network devices 105. In some embodiments, network management platform 101 is a part of one or more of the network devices 105. In some embodiments, one or more processes the network management platform 101 is configured to perform is divided among one or more of the network devices 105 and a processor remote from the network devices 105. In some embodiments, the network management platform 101 is at least partially implemented by a UE 107.

In some embodiments, central data repository 103 has searchable information stored therein that includes stored system data, rules defining various KPIs, network functions capable of being implemented in the network involving one or more of network usage, timing, connected devices, location, network resource consumption, cost data, example network KPIs, KPI monitoring profiles corresponding to one or more users, KPI evaluation profiles corresponding to one or more users, other suitable elements or information, or a combination thereof. Central data repository 103 is a memory such as a memory 805 (FIG. 8) capable of being queried or caused to store data in accordance with one or more embodiments. In some embodiments, the network management platform 101 and the central data repository 103 together form a network orchestrator that implements the communication network 111.

In some embodiments, network management platform 101 generates a graphical user interface that is output to a display by way of a UE 107 or a terminal associated with network management platform 101 for a user (e.g., a network operator, a network administrator, and any personnel which would like to or is responsible to monitor the state of the communication network 111), so as to allow the user to monitor the operating state of the communication network 111. In some embodiments, the user interface is accessible via a web browser such as by way of a website or a web browser plug-in.

The network service provider monitoring system(s) 109 of each of the plurality of network service providers continuously monitor their own corresponding network services and periodically send at predetermined times (e.g., every 5 minutes, every 15 minutes, every 30 minutes, etc.) the monitored system data to the network management platform 101. In some embodiments, the network management platform 101 causes the monitored system data to be stored in the central data repository 103. In some embodiments, the central data repository 103 is controlled by the network operator.

The system data is communicated from the network service provider monitoring systems 109 to the network management platform 101 via one or more of a wireless communication channel, a wired communication channel, enhanced messaging service (EMS), email messaging, data packet transmission, or some other suitable type of data transmission which is optionally the same or different among the plurality of network service providers.

In some embodiments, the network management platform 101 continuously monitors the system data received from the network service provider monitoring system(s) 109 by processing received system data that is stored in the central data repository 103.

In some embodiments, when a user (e.g., a network operator, a network service provider, and/or any personnel that would like to or is responsible to monitor the system) wants to monitor one or more KPIs, the network management platform 101 makes it possible for a user to access to the centralized platform via a UE 107. The network management platform 101 determines the identity of the user based on user credentials, access device, or some other suitable manner, and provides a graphical user interface to the user via a UE 107. In some embodiments, the network management platform 101 limits functions available to the user by way of the graphical user interface depending on the type of user (e.g., a regular user may have access to fewer functions than a VIP user, a network administrator may have access to all functions, etc.).

In use, when a network operator wants to monitor one or more KPIs, the network operator accesses the network management platform 101 by way of the network operator's terminal (e.g., a UE 107 having connectivity to the communication network 111).

After authentication and authorization based on receiving and processing user credentials (e.g., user ID and password, etc.), the network management platform 101 retrieves a user profile of the network operator (e.g., which may be stored in the central data repository 103 or some other suitable memory or database having connectivity to system 100), accesses the central data repository 103 to determine (based on the user profile) which stored system data is related to the network operator, and then generates and presents a list of performance reports that have been created by the user and/or one or more other users that are configured to output KPI value(s) based on how each report is configured. In some embodiments, one or more of the performance reports included in the list of performance reports are configured to output KPI value(s) according to predetermined geography levels, time duration, frequency, technology, equipment type, node information, or some other suitable parameter according to a user-defined set of criteria regarding what information is to be considered when generating the performance report, what information is to be included/excluded in the performance report, a timing and/or frequency of when the performance report should be run and/or what data points should be included in the performance report, an output and/or recipient of the performance report, etc.

The network management platform 101 causes the list of performance reports to be output to the graphical user interface. The network management platform 101 then facilitates viewing the existing performance reports. Based on the user's authorization level according to the user credentials, the network management platform 101 is configured to allow a user to one or more of view the outputs of one or more pre-existing performance reports, edit one or more of the pre-existing performance reports, and/or create new performance reports. In some embodiments, when creating a new performance report, network management platform 101 is configured to facilitate using a system-defined standard report as a template and/or generating a user-created report.

To create a new performance report for inclusion in the list of performance reports, network management platform 101 causes a report detail and node selection interface to be displayed. The report detail and node selection interface is configured to receive user inputs regarding one or more parameters that correspond to various report detail options and user inputs that correspond to node selection(s) for which the report is to be generated. The network management platform 101, for example, is configured to process one or more parameter selection inputs received by way of the report detail and node selection interface comprising a plurality of parameter input fields. Each parameter input field of the plurality of parameter input fields is configured to receive a parameter selection corresponding to a detail for generating a performance report. In some embodiments, the plurality of parameter input fields comprise one or more fields configured to receive a report name, report type, a report mode, a domain, a network service provider name, a network technology, or some other suitable detail.

In some embodiments, the one or more parameter selection inputs are received by way of a drill-down menu in the report detail and node selection interface. In some embodiments, one or more input fields in the report detail and node selection interface that are configured to receive the node selection inputs are drill-down menus. In some embodiments, as one or more of the parameter selection inputs and/or the node selection inputs are received, network management platform 101 is configured to limit selectable and/or presented options in certain parameter input fields and/or node selection input fields. In some embodiments, based on different combinations of parameter selection inputs and/or node selection inputs that are received, the network management platform 101 causes one or more of the parameter selection input fields and/or the node selection input fields to be locked, inaccessible, accessible, viewable, hidden, etc.

In some embodiments, the network management platform 101 is configured to cause different combinations of the parameter input fields to be the minimum parameter input fields that are to have received at least one parameter selection input before the network management platform 101 allows the process of generating a new performance report to continue.

For example, if the graphical user interface comprises five parameter input fields A, B, C, D and E, and if parameter input field A receives a parameter selection input, then the network management platform 101 may be configured to indicate that at least parameter input fields B and C are to receive at least one parameter selection input before the network management platform 101 allows the process to continue. Similarly, in such an example, if parameter input field D receives a parameter selection input, then the network management platform 101 may be configured to indicate that at least parameter input fields C and E are to receive at least one parameter selection input before the network management platform 101 allows the process to continue.

To select one or more nodes for inclusion in the performance report, network management platform 101 processes one or more node selection inputs received by way of the report detail and node selection interface. In some embodiments, the report detail and node selection interface comprises one or more input fields configured to receive an input indicative of at least one of a geographical location, a cluster name, a node aggregation level, or some other suitable parameter for identifying a node. In some embodiments, network management platform 101 is configured to facilitate uploading of data indicative of the node(s) to be included in the performance report. In response to the uploaded data, the network management platform 101 is configured to recognize and parse the information regarding the node inputs and populate the node selection input fields to further the performance report generation process.

Based on the user inputs receive by way of the report detail and node selection interface, network management platform 101 causes the graphical user interface to display and populate a list of one or more KPIs associated with monitoring the communication network. The KPIs, for example, are those that network management platform 101 recognizes as being associated with the one or more parameter selection inputs and the node selection inputs.

In some embodiments, to further narrow the list of KPIs, network management platform 101 facilitates searching the KPIs included in the list of KPIs by way of a word search and/or a group name to which one of the more of the KPIs are linked. For example, if the list of KPIs includes 1,000 KPIs, 10 KPIs are linked to KPI Group 1, 5 KPIs are linked to KPI Group 2, and two of the KPIs in KPI Group 1 and three of the KPIs in KPI Group 2 are also linked to KPI Group 3, network management platform 101 is configured to cause the appropriately linked KPIs to be included in the list of KPIs according to the KPI group that is selected for display in the graphical user interface.

Network management platform 101 is configured to cause one or more of the KPIs in the list of KPIs to be selected for inclusion in the performance report. In some embodiments, one or more of the KPIs are selected for inclusion in the performance report based on a drag and drop operation from the list of KPIs to a performance report generation workspace in the graphical user interface. In some embodiments, the one or more KPIs are selected from the list of KPIs and caused to be added to the performance report generation workspace by double-clicking a KPI in the list of KPIs, or by way of some other suitable action.

According to various embodiments, network management platform 101 is configured to facilitate causing the performance report to be run on-demand and/or according to a predefined schedule. In some embodiments, in response to one or more KPIs being added to the performance report, network management platform 101 causes the graphical user interface to display a scheduling interface. The network management platform 101 then processes one or more user inputs associated with a duration and/or frequency that the performance report is to be run and/or a format by which the performance report is to be output. In some embodiments, the duration is based on a start date and an end date, a start time and an end time, a quantity of days, a quantity of hours, a quantity of years, etc. In some embodiments, the frequency is one or more of every 15 minutes, daily, weekly, monthly, hourly, at a bouncing busy hour, at a network busy hour, at a busiest day, or some other custom frequency timing. In some embodiments, the bouncing busy hour, network busy hour and/or the busiest day is determined by network management platform 101 (e.g., according to the system data stored in the central data repository 103). In some embodiments, the network management platform 101 determines the bouncing busy hour, network busy hour and/or the busiest day according to information defining the bouncing busy hour, network busy hour and/or the busiest day received from the network service provider monitoring system(s) 109.

In some embodiments, the selected format is a file type, a spreadsheet type, a display type, an automatic/system-based generic format, or some other suitable format or style.

In some embodiments, the network management platform 101 is configured to cause more than one selection made by way of the scheduling interface to be combined into one performance report. For example, a performance report may be optionally set to be run daily, weekly and monthly, and/or output in multiple formats.

In some embodiments, the network management platform 101 is configured to facilitate selecting one or more headers that are to be included in the performance report. In some embodiments, the network management platform 101 is configured to automatically populate the headers that are included in the performance report based on the input parameter(s), node selection input(s), duration input(s), frequency input(s), and/or report format selection(s). In some embodiments, one or more header options that are capable of being selected by a user for inclusion in the performance report are limited by the network management platform 101 based on one or more of the input parameter(s), node selection input(s), duration input(s), frequency input(s), and/or report format selection(s).

Network management platform 101 causes the performance report to be generated based on the input parameter(s), node selection input(s), duration input(s), frequency input(s), and/or report format selection(s). The generated performance report is then optionally output based on the selected format, and the generated performance report is caused to be included in a list of performance reports available for selection by way of the graphical user interface.

In some embodiments, network management platform 101 is configured to facilitate adding one or more selected performance reports from the list of performance reports to a new performance report so as to group/compile multiple performance reports into one performance report. In some embodiments, the network management platform 101 is configured to facilitate editing at least one of the time range or the frequency associated with one or more selected performance reports by way of the graphical user interface. In some embodiments, editing one performance report either modifies the existing performance report or serves as a basis for generating a new performance report. In some embodiments, selecting multiple performance reports and editing the selected performance reports causes a new performance report to be generated based on a corresponding time range or frequency for all of the selected performance reports, individually (e.g., a multiple performance report generation process). In some embodiments, editing the selected performance reports invokes a mass performance report modification based on a corresponding time range or frequency for all of the selected performance reports, individually. In some embodiments, selecting multiple performance reports and editing the selected performance reports causes a single new performance report to be generated and included in the list of performance reports that includes. The single new performance report includes, for example, all of the selected performance reports are either based on individually customized duration/frequency/format(s) associated with each of the selected performance reports, or all of the selected performance reports are grouped/compiled together in the new performance report and standardized in the new performance report to have the same duration/frequency/format and be output as a single performance report

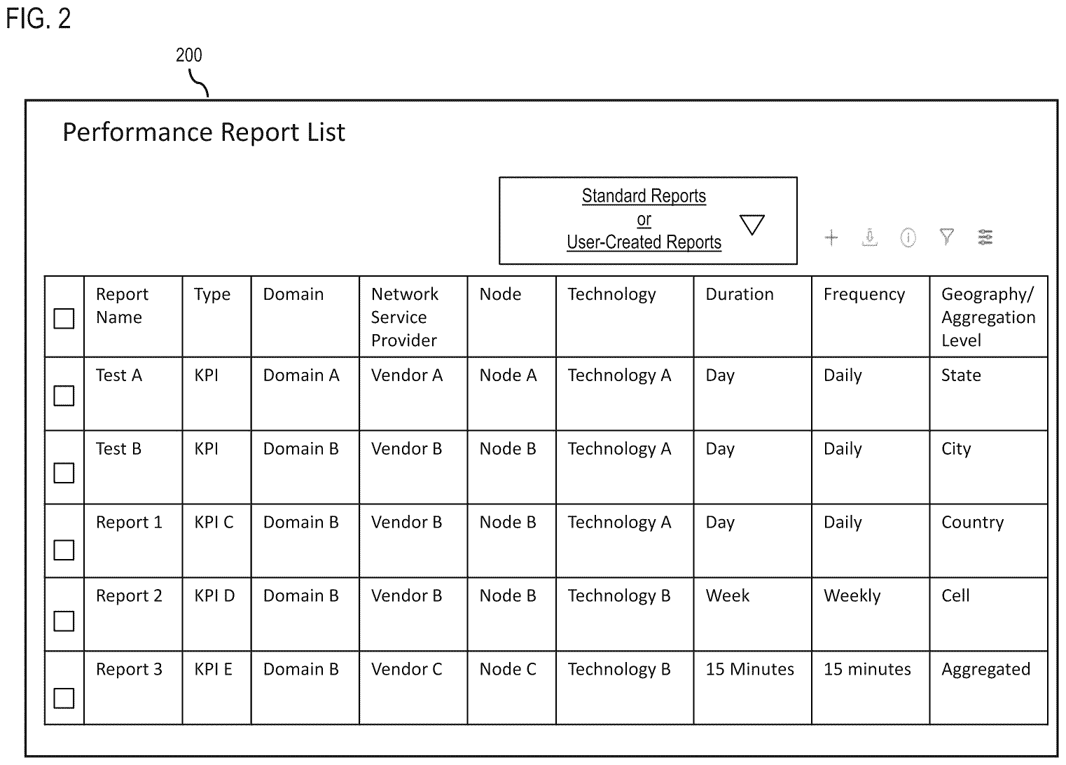

FIG. 2 is a diagram of a graphical user interface 200, in accordance with one or more embodiments. Network management platform 101 is configured to cause graphical user interface 200 to be output to a display.

Graphical user interface 200 is a performance report list. The performance report list comprises a list of performance reports that are pre-existing and available for viewing and/or modification. The performance report list includes high level details regarding the information included in the performance report such as report name, report type, domain, network service provider name, node, technology, duration, frequency, and geography/aggregation level. In some embodiments, greater, fewer, or alternative information is included in the performance report list.

Graphical user interface 200 facilitates the creation of a new performance report that is to be added to the performance report list. In some embodiments, graphical user interface 200 facilitates selecting one or more of the performance reports included in the performance report list for modification, viewing, and/or addition to a new performance report.

In some embodiments, graphical user interface 200 facilitates adding a new performance report based on a selection of a standard report option or a user-created report option and proceeding to a next step in a performance report generation process by selecting a plus sign icon, or some other suitable user interface icon. In some embodiments, graphical user interface 200 filtering the performance reports included in the performance report list by way of a filter mechanism actuated by selecting a filter icon included in graphical user interface 200. In some embodiments, the filter mechanism is limited to the information included in the headers shown in the performance report list. In some embodiments, the filter mechanism includes options that are beyond those indicated in the headers included in the performance report list but by which the performance reports included in the performance report may be identified.

In some embodiments, graphical user interface 200 facilitates adding or removing one or more columns of information included in the performance report list by way of a table option icon or some other suitable table editing option.

In some embodiments, graphical user interface 200 facilitates bulk downloading one or more selected performance reports by way of a download icon included in graphical user interface 200.

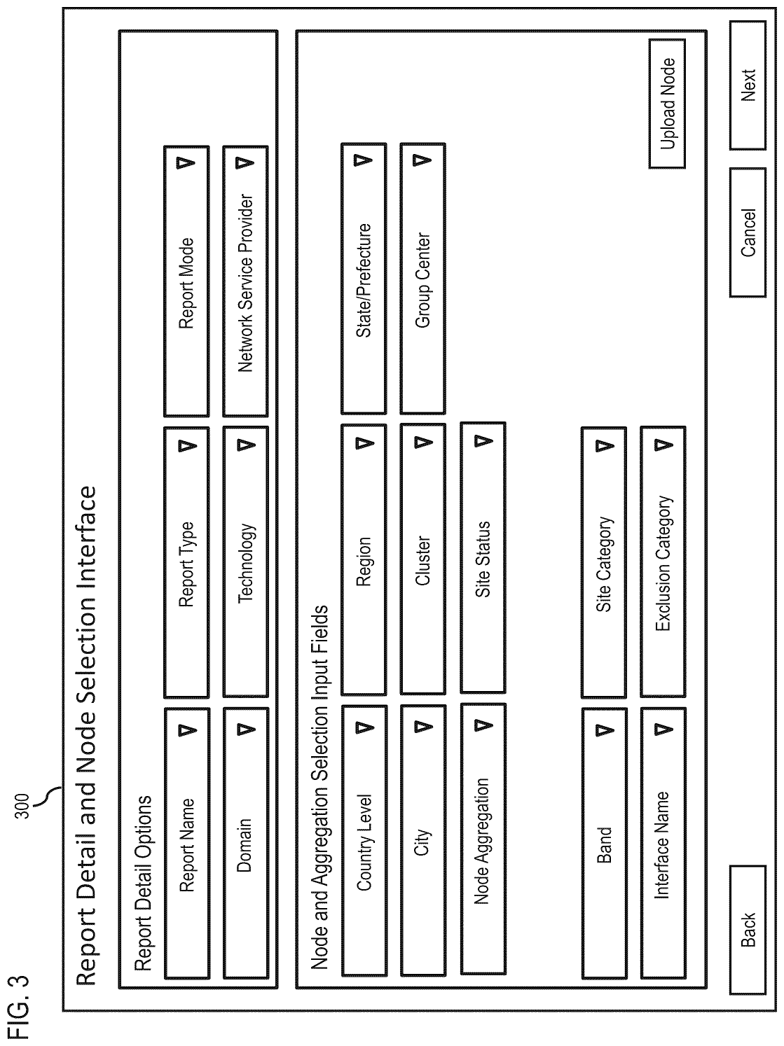

FIG. 3 is a diagram of a graphical user interface 300, in accordance with one or more embodiments. Network management platform 101 is configured to cause graphical user interface 300 to be output to a display.

Graphical user interface 300 is a report detail and node selection interface. Graphical user interface 300 is caused to be displayed based on a user input to create a new performance report in graphical user interface 200 (FIG. 2). In some embodiments, graphical user interface 300 is caused to be displayed only if the user-created report option is selected in graphical user interface 200 before the user input to create a new performance report is received. In some embodiments, graphical user interface 300 is caused to be displayed regardless of whether the user-created report option is selected or the standard report option is selected before the user input to create a new performance report is received. In some embodiments, if the standard report option is selected before the user input to create a new performance report is received, one or more of the input fields included in graphical user interface 300 may be pre-populated based on a preset setting associated with a preset standard report template, for example.

Graphical user interface 300 comprises a plurality of parameter input fields and a plurality of node and aggregation selection input fields. The parameter input fields correspond to various report detail options. The node and aggregation selection input fields correspond to node selection(s) for which the report is to be generated.

In some embodiments, the plurality of parameter input fields comprise one or more fields configured to receive a report name, report type, a report mode, a domain, a network service provider name, a network technology, or some other suitable detail.

In some embodiments, a report type is, for example, a KPI report that displays KPI information for selected criteria, an exception report that captures KPI threshold breaches, a custom aggregation report that includes different combinations of information together regarding KPIs and/or nodes and/or locations etc., a trend report that provides graphical displays and/or spreadsheet and/or algorithmic processing of KPI values for trend analysis, on-the-fly KPI reports that are to be run on demand, or some other suitable report type.

In some embodiments, a report mode is one or more of on-demand, scheduled, regularly-occurring, repeating, etc. In some embodiments, the domain comprises a radio area network (RAN), core network, etc. In some embodiments, the network technology comprises 3G, 4G, LTE, 5G, etc.

In some embodiments, the one or more parameter selection inputs are received by way of a drop-down menu, radio button(s), textual inputs, some other suitable manner, or a combination thereof.

In some embodiments, the plurality of node and aggregation selection inputs comprise fields to receive an input indicative of at least one of a geographical location, a cluster name, a node aggregation level, a country level, a region, a state/prefecture, a city, a group center, a site status, a node aggregation, a frequency band, a site category, an interface name, an exclusion category, or some other suitable parameter for identifying a node or group of nodes. In some embodiments, one or more of the node and aggregation selection inputs facilitates selecting all of the options included therein for aggregating all of the options and/or selecting two of more of the options included therein for aggregating two or more of the options included in at least one of the node and aggregation selection input fields.

In some embodiments, the one or more node and aggregation selection inputs are received by way of a drop-down menu, radio button(s), textual inputs, some other suitable manner, or a combination thereof.

In some embodiments, the one or more parameter selection inputs and/or the node selection and aggregation inputs are received by way of a drill-down menu in the report detail and node selection interface.

In some embodiments, as one or more of the parameter selection inputs and/or the node selection inputs are received, network management platform 101 is configured to limit selectable and/or presented options in certain parameter input fields and/or node selection input fields. In some embodiments, based on inputs receive by different combinations of parameter selection inputs and/or node selection inputs, the network management platform 101 causes one or more of the parameter selection input fields and/or the node selection input fields to be locked, inaccessible, accessible, viewable, hidden, etc.

In some embodiments, the network management platform 101 is configured to cause different combinations of the parameter input fields to be the minimum parameter input fields that are to have received at least one parameter selection input before the network management platform 101 allows the process of generating a new performance report to continue.

After a user has input at least the minimum parameter inputs and/or the minimum node and aggregation selection inputs, the user may then select a “next” option, or some other suitable instruction icon to cause the network management platform 101 to advance to a next step in the performance report generation process.

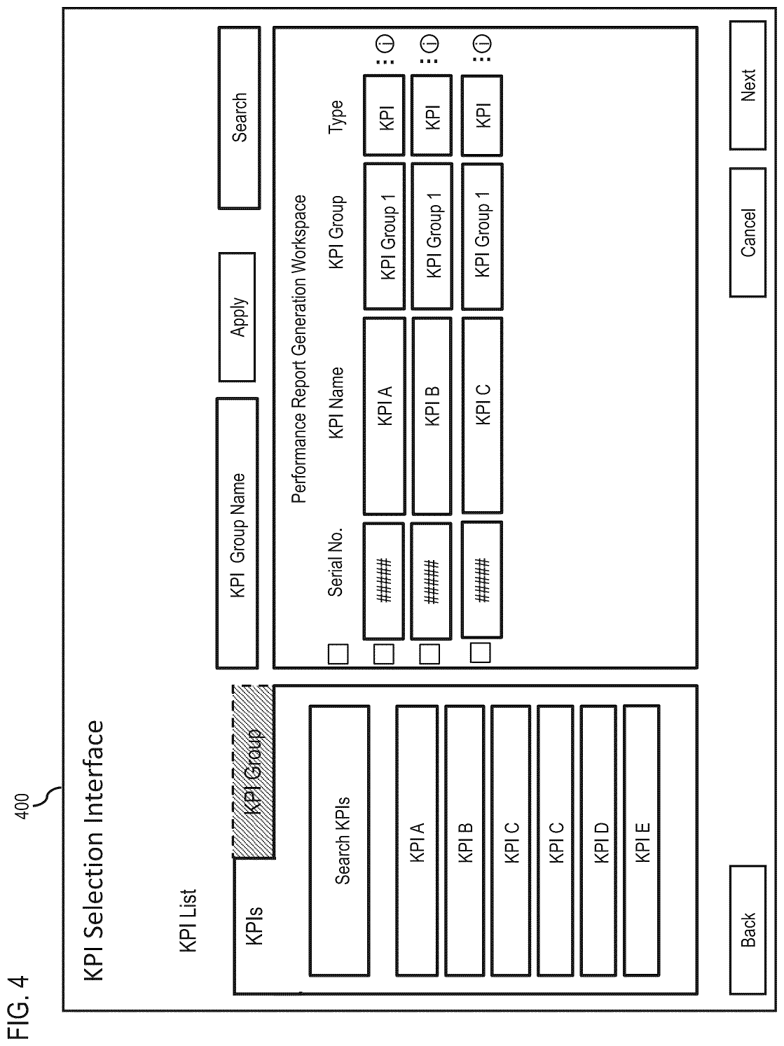

FIG. 4 is a diagram of a graphical user interface 400, in accordance with one or more embodiments. Network management platform 101 is configured to cause graphical user interface 400 to be output to a display.

Graphical user interface 400 is a KPI selection interface. Graphical user interface 400 is caused to be displayed based on a user input to proceed to a next step in generating the performance report in graphical user interface 300 (FIG. 3).

Based on the user inputs receive by way of the parameter input fields and the node selection and aggregation selection input fields in graphical user interface 200, network management platform 101 causes graphical user interface 400 to display and populate a list of one or more KPIs associated with monitoring the communication network. The KPIs included in the KPI list in user interface 400 are those that network management platform 101 recognizes as being associated with the one or more parameter selection inputs and the node selection inputs.

User interface 400 includes options to further narrow the list of KPIs. In some embodiments, user interface 400 includes a search KPI input field, a KPI group name input field, and/or a KPI group tab. The search KPI input field and the KPI group name input field are configured to receive word searches for KPI names, serial numbers, KPI groups, etc. The network management platform then searches the central data repository 103 for corresponding KPIs and filters the list of KPIs accordingly. If a KPI group tab in included/selected, the KPI group tab facilitates a view of available KPI group names that are optionally expandable to view what KPIs are included in each KPI group. In some embodiments, the network management platform 101 narrows the KPI groups based on the inputs received by way of graphical user interface 300 and/or by way of the search KPI input field and/or the KPI group name input field.

Graphical user interface 400 includes a performance report generation workspace within which one or more selected KPIs are caused to appear based on one or more of the KPIs in the list of KPIs being selected for inclusion in the performance report. In some embodiments, one or more of the KPIs are selected for inclusion in the performance report based on a drag and drop operation from the list of the one or more KPIs to a performance report generation workspace in the graphical user interface. In some embodiments, the one or more KPIs are selected from the list of KPIs and caused to be added to the performance report generation workspace by double-clicking a KPI in the list of KPIs, or by way of some other suitable action.

Graphical user interface 400 is shown in FIG. 4 as an example wherein KPI A, KPI B and KPI C are selected by causing the KPIs A-C to be added to the performance report generation workspace. The performance report generation workspace includes the KPI name, a serial number associated with the KPI, the KPI Group with which the KPI is associated, and the type of KPI that is added. In some embodiments, the KPI selection workspace displays one of the serial number or the KPI name.

After a user has selected one or more KPIs, the user may then proceed to a next step in the performance report generation process by selecting a “next” option, or some other suitable instruction icon in graphical user interface 400.

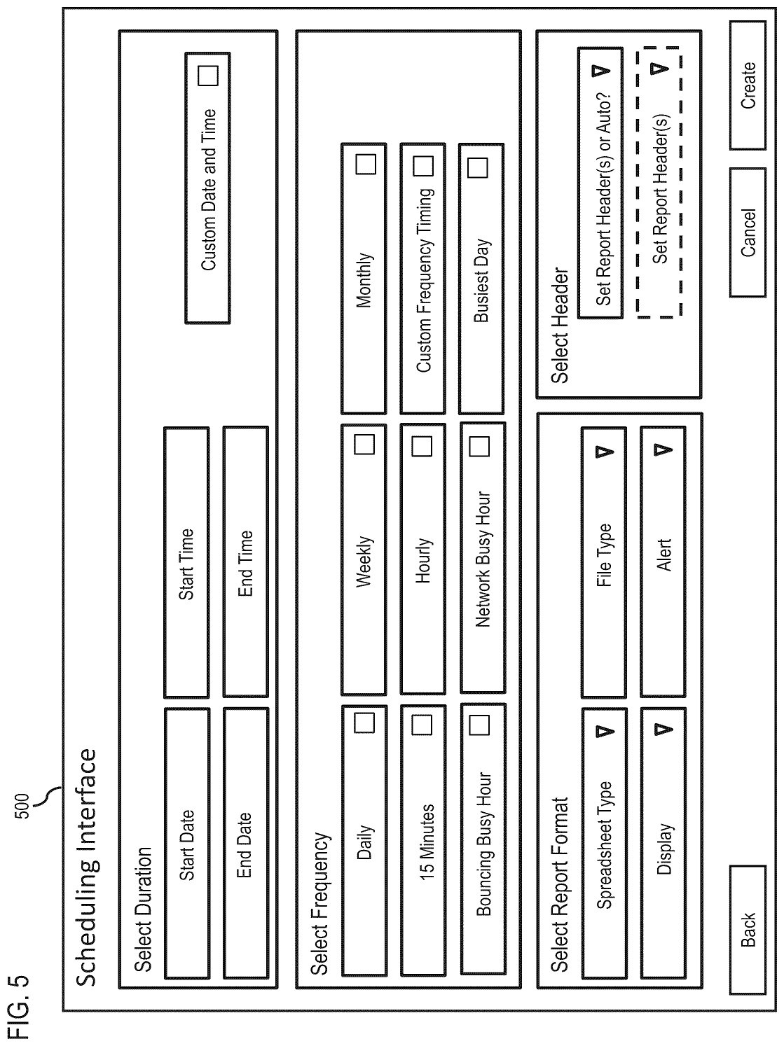

FIG. 5 is a diagram of a graphical user interface 500, in accordance with one or more embodiments. Network management platform 101 is configured to cause graphical user interface 500 to be output to a display.

Graphical user interface 500 is a KPI scheduling interface. Graphical user interface 500 is caused to be displayed based on a user input to proceed to a next step in generating the performance report in graphical user interface 400 (FIG. 4).

Graphical user interface 500 is a scheduling interface. Graphical user interface 500 includes input fields configured to receive user inputs associated with a duration and/or frequency that the performance report is to be run and/or a format by which the performance report is to be output.

In some embodiments, the duration input fields are configured to receive user inputs corresponding to a start date and an end date, a start time and an end time, a quantity of days, a quantity of hours, a quantity of months, a quantity of years, etc. In some embodiments, the frequency input fields are configured to receive user inputs corresponding to a selection of one or more of every 15 minutes, daily, weekly, monthly, hourly, at a bouncing busy hour, at a network busy hour, at a busiest day, or some other custom frequency timing. In some embodiments, the bouncing busy hour, network busy hour and/or the busiest day is determined by network management platform 101 according to the system data stored in the central data repository 103.

In some embodiments, the network management platform 101 determines the bouncing busy hour, network busy hour and/or the busiest day according to information defining the bouncing busy hour, network busy hour and/or the busiest day received from the network service provider monitoring system(s) 109.

In some embodiments, the selected format input fields are configured to receive user inputs corresponding to one or more of a file type, a spreadsheet type, a display type, an automatic/system-based generic format, or some other suitable format or style.

In some embodiments, graphical user interface 500 is configured to receive more than one selection made by way of the scheduling interface to be combined into one performance report. For example, a performance report may be optionally set to be run daily, weekly and monthly, and/or output in multiple formats.

In some embodiments, graphical user interface 500 includes header selection input fields that are configured to receive user inputs for selecting one or more headers that are to be included in the performance report.

In some embodiments, one or more header options that are capable of being selected by a user for inclusion in the performance report are limited in graphical user interface 500 by the network management platform 101 based on one or more of the input parameter(s), node selection input(s), duration input(s), frequency input(s), and/or report format selection(s). In some embodiments, the network management platform 101 is configured to automatically populate the headers that are included in the performance report based on the input parameter(s), node selection input(s), duration input(s), frequency input(s), and/or report format selection(s), and the header selection input field is locked and inaccessible or optional for modifying the network management platform 101-automatically populated headers.

After a user has selected the duration, frequency (which may be on demand for example), report format, and/or headers, the user may then create the performance report by selecting a “create” option, or some other suitable instruction icon in graphical user interface 400.

Network management platform 101 then causes the performance report to be generated based on the input parameter(s), node selection input(s), duration input(s), frequency input(s), and/or report format selection(s). The performance report is then optionally output based on the selected format, and the generated performance report is caused to be included in the list of performance reports available for selection by way of the graphical user interface 200. In some embodiments, the parameters/configurations selected from graphical user interfaces 300, 400 and 500 discussed with respect to FIGS. 3, 4 and 5 (of FIGS. 3-5) are stored in a report generation profile (or “configuration profile”) in a database such as central data repository 103, or other suitable memory, such that the system will automatically and dynamically generate the performance report based on the configuration profile.

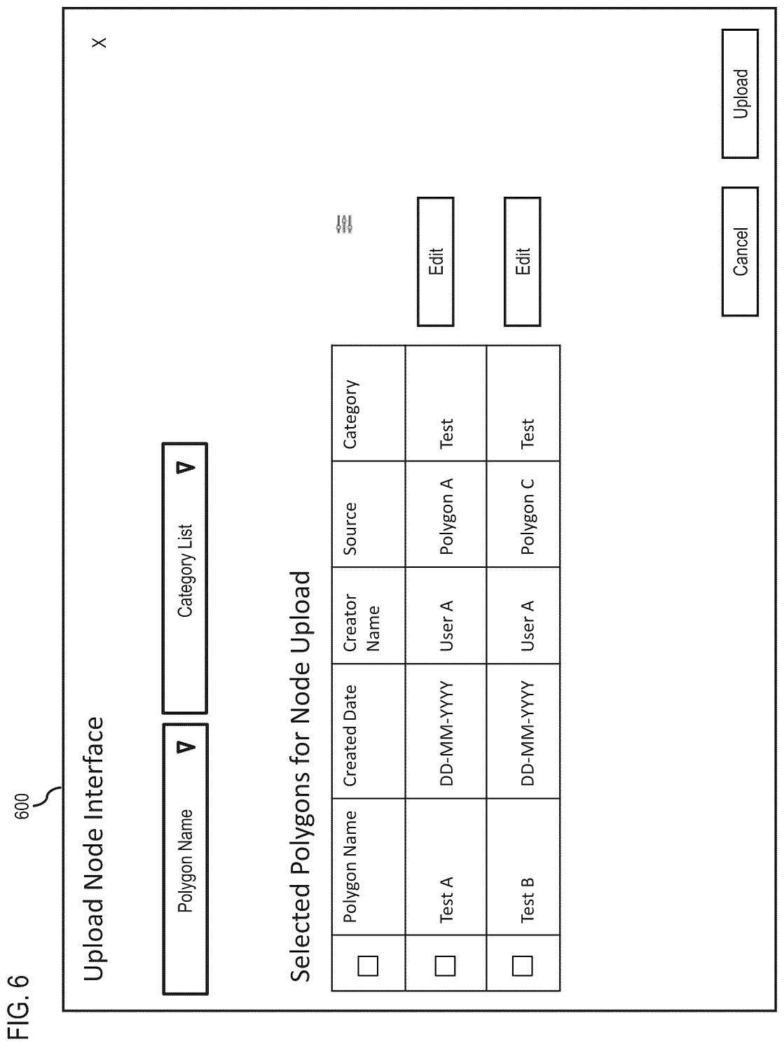

FIG. 6 is a diagram of a graphical user interface 600, in accordance with one or more embodiments. Network management platform 101 is configured to cause graphical user interface 600 to be output to a display.

Graphical user interface 600 is an upload node interface. Graphical user interface 600 is caused to be displayed based on a selection of an upload node option icon in graphical user interface 300 (FIG. 3).

In some embodiments, graphical user interface 600 includes input fields for searching for a polygon name for existing polygon topology to find node information that is capable of being identified and uploaded. The polygon name input field is one or more of a word search, drop down list, or other suitable field by which a user may search for and find available polygons. In some embodiments, graphical user interface 600 includes a category list input field for searching existing polygon topology for node information that is capable of being identified and uploaded. The category list input field is one or more of a word search, drop down list, or other suitable field by which a user may search for and find available polygons based on predefined associations according to an established category.

Based on a selection made from any discovered options in the polygon name input field and/or the category list, the selected polygon(s) are added to a list of selected polygons for node upload. The selected list of polygons for node upload includes the polygon name, created date that corresponds to one of the polygon creation date or the date the polygon is added to the list of polygons for node upload, the creator name, source and category. In some embodiments, graphical user interface 600 includes options to edit information about the selected polygons for node upload such as the polygon name, source and category.

Graphical user interface 600 then facilitates uploading the node information to the network management platform 101 and inclusion in the options available in graphical user interface 300 based on a user selection of an “upload” icon, or some other suitable instruction icon in graphical user interface 600. In some embodiments, a user may navigate back to user interface 300 by selecting “cancel” icon or an “x” icon to close graphical user interface 600, or some other suitable instruction icon in graphical user interface 600.

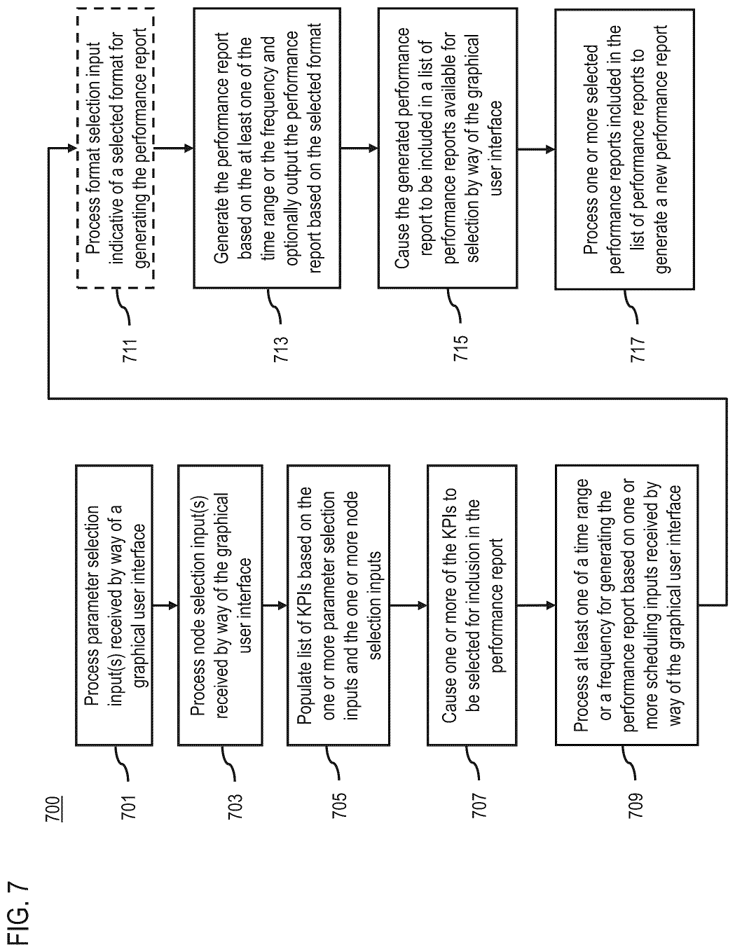

FIG. 7 is a flowchart of a process 900 for generating a performance report associated with monitoring one or more KPI values, in accordance with one or more embodiments. In some embodiments, the network management platform 101 (FIG. 1) performs the process 900.

In step 701, one or more parameter selection inputs received by way of a graphical user interface comprising a plurality of parameter input fields are processed. Each parameter input field of the plurality of parameter input fields is configured to receive a parameter selection corresponding to a detail for generating a performance report. In some embodiments, the plurality of parameter input fields comprise one or more fields configured to receive a report name, report type, a report mode, a domain, a network service provider, a network technology, a domain, or some other suitable detail.

In some embodiments, the one or more parameter selection inputs are received by way of a drill-down menu in the graphical user interface.

In step 703, one or more node selection inputs received by way of the graphical user interface are processed. In some embodiments, the one or more node selection inputs comprise one or more fields configured to receive an input indicative of at least one of a geographical location, a cluster name, a node aggregation level, or some other suitable parameter for identifying a node.

In some embodiments, the one or more node selection inputs is received by way of a drill-down menu in the graphical user interface.

In step 705, a list of one or more KPIs associated with monitoring a communication network is caused to be populated based on the one or more parameter selection inputs and the one or more node selection inputs.

In step 707, one or more of the KPIs are caused to be selected for inclusion in the performance report based on a selection of one or more of the KPIs included in the list of the one or more KPIs.

In some embodiments, one or more of the KPIs are selected for inclusion in the performance report based on a drag and drop operation from the list of the one or more KPIs to a performance report generation workspace.

In step 709, at least one of a time range or a frequency is processed for generating the performance report based on one or more scheduling inputs received by way of the graphical user interface.

In some embodiments, the time range is based on a start time and an end time received by way of the graphical user interface. In some embodiments, the time range further comprises a start date and an end date received by way of the graphical user interface. In some embodiments, frequency comprises a bouncing busy hour. In some embodiments, the frequency comprises a network busiest hour. In some embodiments, the frequency comprises a busiest day.

In optional step 711, a format selection input indicative of a selected format for generating the performance report is processed. In some embodiments, the selected format is a file type, a spreadsheet type, a display type, an automatic/system-based generic format, or some other suitable format or style.

In step 713, the performance report is caused to be generated based on the at least one of the time range or the frequency, and the performance report is optionally output based on the selected format.

In step 715, the generated performance report is caused to be included in a list of performance reports available for selection by way of the graphical user interface.

In step 717, one or more selected performance reports included in the list of performance reports are processed to generate a new performance report. At least one of the graphical user interface is configured to facilitate editing at least one of the time range or the frequency associated with the one or more selected performance reports to cause the new performance report to be generated based on a corresponding time range or frequency.

FIG. 8 is a functional block diagram of a computer or processor-based system 800 upon which or by which an embodiment is implemented.

Processor-based system 800 is programmed to generate a performance report associated with monitoring one or more KPI values, as described herein, and includes, for example, bus 801, processor 803, and memory 805 components.

In some embodiments, the processor-based system is implemented as a single “system on a chip.” Processor-based system 800, or a portion thereof, constitutes a mechanism for performing one or more steps of generating a performance report associated with monitoring one or more KPI values.

In some embodiments, the processor-based system 800 includes a communication mechanism such as bus 801 for transferring and/or receiving information and/or instructions among the components of the processor-based system 800. Processor 803 is connected to the bus 801 to obtain instructions for execution and process information stored in, for example, the memory 805. In some embodiments, the processor 803 is also accompanied with one or more specialized components to perform certain processing functions and tasks such as one or more digital signal processors (DSP), or one or more application-specific integrated circuits (ASIC). A DSP typically is configured to process real-world signals (e.g., sound) in real time independently of the processor 803. Similarly, an ASIC is configurable to perform specialized functions not easily performed by a more general-purpose processor. Other specialized components to aid in performing the functions described herein optionally include one or more field programmable gate arrays (FPGA), one or more controllers, or one or more other special-purpose computer chips.

In one or more embodiments, the processor (or multiple processors) 803 performs a set of operations on information as specified by a set of instructions stored in memory 805 related to generating a performance report associated with monitoring one or more KPI values. The execution of the instructions causes the processor to perform specified functions.

The processor 803 and accompanying components are connected to the memory 805 via the bus 801. The memory 805 includes one or more of dynamic memory (e.g., RAM, magnetic disk, writable optical disk, etc.) and static memory (e.g., ROM, CD-ROM, etc.) for storing executable instructions that when executed perform the steps described herein to generate a performance report associated with monitoring one or more KPI values. The memory 805 also stores the data associated with or generated by the execution of the steps.

In one or more embodiments, the memory 805, such as a random-access memory (RAM) or any other dynamic storage device, stores information including processor instructions for generating a performance report associated with monitoring one or more KPI values. Dynamic memory allows information stored therein to be changed. RAM allows a unit of information stored at a location called a memory address to be stored and retrieved independently of information at neighboring addresses. The memory 805 is also used by the processor 803 to store temporary values during execution of processor instructions. In various embodiments, the memory 805 is a read only memory (ROM) or any other static storage device coupled to the bus 801 for storing static information, including instructions, that is not capable of being changed by processor 803. Some memory is composed of volatile storage that loses the information stored thereon when power is lost. In some embodiments, the memory 805 is a non-volatile (persistent) storage device, such as a magnetic disk, optical disk or flash card, for storing information, including instructions, that persists even when the system 800 is turned off or otherwise loses power.

The term “computer-readable medium” as used herein refers to any medium that participates in providing information to processor 803, including instructions for execution. Such a medium takes many forms, including, but not limited to computer-readable storage medium (e.g., non-volatile media, volatile media). Non-volatile media includes, for example, optical or magnetic disks. Volatile media include, for example, dynamic memory. Common forms of computer-readable media include, for example, a floppy disk, a flexible disk, a hard disk, a magnetic tape, another magnetic medium, a CD-ROM, CDRW, DVD, another optical medium, punch cards, paper tape, optical mark sheets, another physical medium with patterns of holes or other optically recognizable indicia, a RAM, a PROM, an EPROM, a FLASH-EPROM, an EEPROM, a flash memory, another memory chip or cartridge, or another medium from which a computer can read. The term computer-readable storage medium is used herein to refer to a computer-readable medium.

An aspect of this description is related to method comprising processing, by a processor, one or more parameter selection inputs received by way of a graphical user interface comprising a plurality of parameter input fields. Each parameter input field of the plurality of parameter input fields is configured to receive a parameter selection corresponding to a detail for generating a performance report. The method also comprises processing one or more node selection inputs received by way of the graphical user interface. The method further comprises causing a list of one or more key performance indicators (KPIs) associated with monitoring a communication network to be populated based on the one or more parameter selection inputs and the one or more node selection inputs. The method additionally comprises causing one or more of the KPIs to be selected for inclusion in the performance report based on a selection of one or more of the KPIs included in the list of the one or more KPIs. The method also comprises processing at least one of a time range or a frequency for generating the performance report based on one or more scheduling inputs received by way of the graphical user interface. The method further comprises causing the performance report to be generated based on the at least one of the time range or the frequency.

Another aspect of this description is related to an apparatus comprising a processor and a memory. The memory has instructions stored thereon that, when executed by the processor, cause the apparatus to process one or more parameter selection inputs received by way of a graphical user interface comprising a plurality of parameter input fields. Each parameter input field of the plurality of parameter input fields is configured to receive a parameter selection corresponding to a detail for generating a performance report. The apparatus is also caused to process one or more node selection inputs received by way of the graphical user interface. The apparatus is further caused to cause a list of one or more key performance indicators (KPIs) associated with monitoring a communication network to be populated based on the one or more parameter selection inputs and the one or more node selection inputs. The apparatus is additionally caused to cause one or more of the KPIs to be selected for inclusion in the performance report based on a selection of one or more of the KPIs included in the list of the one or more KPIs. The apparatus is further caused to process at least one of a time range or a frequency for generating the performance report based on one or more scheduling inputs received by way of the graphical user interface. The apparatus is further caused to cause the performance report to be generated based on the at least one of the time range or the frequency.

Another aspect of this description is related to a non-transitory computer readable having instructions stored thereon that, when executed by the processor, cause an apparatus to process one or more parameter selection inputs received by way of a graphical user interface comprising a plurality of parameter input fields. Each parameter input field of the plurality of parameter input fields is configured to receive a parameter selection corresponding to a detail for generating a performance report. The apparatus is also caused to process one or more node selection inputs received by way of the graphical user interface. The apparatus is further caused to cause a list of one or more key performance indicators (KPIs) associated with monitoring a communication network to be populated based on the one or more parameter selection inputs and the one or more node selection inputs. The apparatus is additionally caused to cause one or more of the KPIs to be selected for inclusion in the performance report based on a selection of one or more of the KPIs included in the list of the one or more KPIs. The apparatus is further caused to process at least one of a time range or a frequency for generating the performance report based on one or more scheduling inputs received by way of the graphical user interface. The apparatus is further caused to cause the performance report to be generated based on the at least one of the time range or the frequency.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A method, comprising:
processing, by a processor, one or more parameter selection inputs received by way of a graphical user interface comprising a plurality of parameter input fields, each parameter input field of the plurality of parameter input fields being configured to receive a parameter selection corresponding to a detail for generating a performance report;
processing one or more node selection inputs received by way of the graphical user interface;
causing a list of one or more key performance indicators (KPIs) associated with monitoring a communication network to be populated based on the one or more parameter selection inputs and the one or more node selection inputs;
causing one or more of the KPIs to be selected for inclusion in the performance report based on a selection of one or more of the KPIs included in the list of the one or more KPIs;
processing at least one of a time range or a frequency for generating the performance report based on one or more scheduling inputs received by way of the graphical user interface; and
causing the performance report to be generated based on the at least one of the time range or the frequency.

2. The method of claim 1, wherein the one or more parameter selection inputs is received by way of a drill-down menu in the graphical user interface.

3. The method of claim 2, wherein the one or more node selection inputs is received by way of a drill-down menu in the graphical user interface.

4. The method of claim 1, wherein one or more of the KPIs are selected for inclusion in the performance report based on a drag and drop operation from the list of the one or more KPIs to a performance report generation workspace.

5. The method of claim 1, further comprising:
processing a format selection input indicative of a selected format for generating the performance report,
wherein the performance report is generated and output based on the selected format.

6. The method of claim 1, wherein the time range is based on a start time and an end time received by way of the graphical user interface.

7. The method of claim 6, wherein the time range further comprises a start date and an end date received by way of the graphical user interface.

8. The method of claim 7, wherein the frequency comprises a bouncing busy hour.

9. The method of claim 7, wherein the frequency comprises a network busiest hour.

10. The method of claim 1, further comprising:
causing the generated performance report to be included in a list of performance reports available for selection by way of the graphical user interface; and
processing one or more selected performance reports included in the list of performance reports to generate a new performance report,
wherein, at least one of the graphical user interface is configured to facilitate editing at least one of the time range or the frequency associated with the one or more selected performance reports to cause the new performance report to be generated based on a corresponding time range or frequency.

11. An apparatus, comprising:
a processor; and
a memory having instructions stored thereon that, when executed by the processor, cause the apparatus to:
process one or more parameter selection inputs received by way of a graphical user interface comprising a plurality of parameter input fields, each parameter input field of the plurality of parameter input fields being configured to receive a parameter selection corresponding to a detail for generating a performance report;
process one or more node selection inputs received by way of the graphical user interface;
cause a list of one or more key performance indicators (KPIs) associated with monitoring a communication network to be populated based on the one or more parameter selection inputs and the one or more node selection inputs;
cause one or more of the KPIs to be selected for inclusion in the performance report based on a selection of one or more of the KPIs included in the list of the one or more KPIs;
process at least one of a time range or a frequency for generating the performance report based on one or more scheduling inputs received by way of the graphical user interface; and
cause the performance report to be generated based on the at least one of the time range or the frequency.

12. The apparatus of claim 11, wherein the one or more parameter selection inputs is received by way of a drill-down menu in the graphical user interface.

13. The apparatus of claim 12, wherein the one or more node selection inputs is received by way of a drill-down menu in the graphical user interface.

14. The apparatus of claim 11, wherein one or more of the KPIs are selected for inclusion in the performance report based on a drag and drop operation from the list of the one or more KPIs to a performance report generation workspace.

15. The apparatus of claim 11, wherein the apparatus is further caused to:
process a format selection input indicative of a selected format for generating the performance report,
wherein the performance report is generated and output based on the selected format.

16. The apparatus of claim 11, wherein the time range is based on a start time and an end time received by way of the graphical user interface.

17. The apparatus of claim 16, wherein the time range further comprises a start date and an end date received by way of the graphical user interface.

18. The apparatus of claim 17, wherein the frequency comprises a bouncing busy hour.

19. The apparatus of claim 17, wherein the frequency comprises a network busiest hour.

20. A non-transitory computer readable medium having instructions stored thereon that, when executed by a processor, cause an apparatus to:
process one or more parameter selection inputs received by way of a graphical user interface comprising a plurality of parameter input fields, each parameter input field of the plurality of parameter input fields being configured to receive a parameter selection corresponding to a detail for generating a performance report;
process one or more node selection inputs received by way of the graphical user interface;
cause a list of one or more key performance indicators (KPIs) associated with monitoring a communication network to be populated based on the one or more parameter selection inputs and the one or more node selection inputs;
cause one or more of the KPIs to be selected for inclusion in the performance report based on a selection of one or more of the KPIs included in the list of the one or more KPIs;
process at least one of a time range or a frequency for generating the performance report based on one or more scheduling inputs received by way of the graphical user interface; and
cause the performance report to be generated based on the at least one of the time range or the frequency.
